SEQUENCE LISTING (35 sequences)

SEQ ID NO: 1 - DNA, 405 bp, Unknown
  CDS (1)..(405): basf-dewA
atgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgag

SEQ ID NO: 2 - protein, 135 aa, Unknown
  basf-dewA
MRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAE

SEQ ID NO: 3 - DNA, 471 bp, Unknown
  CDS (1)..(471): basf-rodA
atgaagttctccattgctgccgctgtcgttgctttcgccgcctccgtcgcggccctccctcctgcccatgattcccagttcgctggcaatggtgttggcaacaagggcaacagcaacgtcaagttccctgtccccgaaaacgtgaccgtcaagcaggcctccgacaagtgcggtgaccaggcccagctctcttgctgcaacaaggccacgtacgccggtgacaccacaaccgttgatgagggtcttctgtctggtgccctcagcggcctcatcggcgccgggtctggtgccgaaggtcttggtctcttcgatcagtgctccaagcttgatgttgctgtcctcattggcatccaagatcttgtcaaccagaagtgcaagcaaaacattgcctgctgccagaactccccctccagcgcggatggcaaccttattggtgtcggtctcccttgcgttgcccttggctccatcctc

SEQ ID NO: 4 - protein, 157 aa, Unknown
  basf-rodA
MKFSIAAAVVAFAASVAALPPAHDSQFAGNGVGNKGNSNVKFPVPENVTVKQASDKCGDQAQLSCCNKATYAGDTTTVDEGLLSGALSGLIGAGSGAEGLGLFDQCSKLDVAVLIGIQDLVNQKCKQNIACCQNSPSSADGNLIGVGLPCVALGSIL

SEQ ID NO: 5 - DNA, 336 bp, Unknown
  CDS (1)..(336): basf-HypA
atgatctctcgcgtccttgtcgctgctctcgtcgctctccccgctcttgttactgcaactcctgctcccggaaagcctaaagccagcagtcagtgcgacgtcggtgaaatccattgctgtgacactcagcagactcccgaccacaccagcgccgccgcgtctggtttgcttggtgttcccatcaaccttggtgctttcctcggtttcgactgtacccccatttccgtccttggcgtcggtggcaacaactgtgctgctcagcctgtctgctgcacaggaaatcaattcaccgcattgattaacgctcttgactgctctcctgtcaatgtcaacctc

SEQ ID NO: 6 - protein, 112 aa, Unknown
  basf-HypA
MISRVLVAALVALPALVTATPAPGKPKASSQCDVGEIHCCDTQQTPDHTSAAASGLLGVPINLGAFLGFDCTPISVLGVGGNNCAAQPVCCTGNQFTALINALDCSPVNVNL

SEQ ID NO: 7 - DNA, 357 bp, Unknown
  CDS (1)..(357): basf-HypB
atggtcagcacgttcatcactgtcgcaaagacccttctcgtcgcgctcctcttcgtcaatatcaatatcgtcgttggtactgcaactaccggcaagcattgtagcaccggtcctatcgagtgctgcaagcaggtcatggattctaagagccctcaggctacggagcttcttacgaagaatggccttggcctgggtgtccttgctggcgtgaagggtcttgttggcgcgaattgcagccctatcacggcaattggtattggctccggcagccaatgctctggccagaccgtttgctgccagaataataatttcaacggtgttgtcgctattggttgcactcccattaatgccaatgtg

SEQ ID NO: 8 - protein, 119 aa, Unknown
  basf-HypB
MVSTFITVAKTLLVALLFVNINIVVGTATTGKHCSTGPIECCKQVMDSKSPQATELLTKNGLGLGVLAGVKGLVGANCSPITAIGIGSGSQCSGQTVCCQNNNFNGVVAIGCTPINANV

SEQ ID NO: 9 - DNA, 408 bp, Unknown
  CDS (1)..(408): basf-sc3
atgttcgcccgtctccccgtcgtgttcctctacgccttcgtcgcgttcggcgccctcgtcgctgccctcccaggtggccacccgggcacgaccacgccgccggttacgacgacggtgacggtgaccacgccgccctcgacgacgaccatcgccgccggtggcacgtgtactacggggtcgctctcttgctgcaaccaggttcaatcggcgagcagcagccctgttaccgccctcctcggcctgctcggcattgtcctcagcgacctcaacgttctcgttggcatcagctgctctcccctcactgtcatcggtgtcggaggcagcggctgttcggcgcagaccgtctgctgcgaaaacacccaattcaacgggctgatcaacatcggttgcacccccatcaacatcctc

SEQ ID NO: 10 - protein, 136 aa, Unknown
  basf-sc3
MFARLPVVFLYAFVAFGALVAALPGGHPGTTTPPVTTTVTVTTPPSTTTIAAGGTCTTGSLSCCNQVQSASSSPVTALLGLLGIVLSDLNVLVGISCSPLTVIGVGGSGCSAQTVCCENTQFNGLINIGCTPINIL

SEQ ID NO: 11 - DNA, 483 bp, Unknown
  CDS (1)..(483): basf-BASF1
atgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcctcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccaggtcaacaagcagtgcaagcagaacatcgcctgctgccagaactccccttccgacgccaccggctccctcgtcaacctcggcctcggcaacccttgcatccctgtctccctcctccatatg

SEQ ID NO: 12 - protein, 161 aa, Unknown
  basf-BASF1
MKFSVSAAVLAFAASVAALPQHDSAAGNGNGVGNKFPVPDDVTVKQATDKCGDQAQLSCCNKATYAGDVLTDIDEGILAGLLKNLIGGGSGSEGLGLFDQCVKLDLQISVIGIPIQDLLNQVNKQCKQNIACCQNSPSDATGSLVNLGLGNPCIPVSLLHM

SEQ ID NO: 13 - DNA, 465 bp, Unknown
  CDS (1)..(465): basf-BASF2
atgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccagcagtgcaagcagaacatcgcctgctgccagaactccccttccgacgccaccggctccctcgtcaacctcggcaacccttgcatccctgtctccctcctccatatg

SEQ ID NO: 14 - protein, 155 aa, Unknown
  basf-BASF2
MKFSVSAAVLAFAASVAALPQHDSAAGNGNGVGNKFPVPDDVTVKQATDKCGDQAQLSCCNKATYAGDVTDIDEGILAGLLKNLIGGGSGSEGLGLFDQCVKLDLQISVIGIPIQDLLNQQCKQNIACCQNSPSDATGSLVNLGNPCIPVSLLHM

SEQ ID NO: 15 - DNA, 882 bp, Unknown
  CDS (1)..(882): basf-yaad
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctgg

SEQ ID NO: 16 - protein, 294 aa, Unknown
  basf-yaad
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGW

SEQ ID NO: 17 - DNA, 591 bp, Unknown
  CDS (1)..(591): basf-yaae
atgggattaacaataggtgtactaggacttcaaggagcagttagagagcacatccatgcgattgaagcatgcggcgcggctggtcttgtcgtaaaacgtccggagcagctgaacgaagttgacgggttgattttgccgggcggtgagagcacgacgatgcgccgtttgatcgatacgtatcaattcatggagccgcttcgtgaattcgctgctcagggcaaaccgatgtttggaacatgtgccggattaattatattagcaaaagaaattgccggttcagataatcctcatttaggtcttctgaatgtggttgtagaacgtaattcatttggccggcaggttgacagctttgaagctgatttaacaattaaaggcttggacgagccttttactggggtattcatccgtgctccgcatattttagaagctggtgaaaatgttgaagttctatcggagcataatggtcgtattgtagccgcgaaacaggggcaattccttggctgctcattccatccggagctgacagaagatcaccgagtgacgcagctgtttgttgaaatggttgaggaatataagcaaaaggcacttgta

SEQ ID NO: 18 - protein, 197 aa, Unknown
  basf-yaae
MGLTIGVLGLQGAVREHIHAIEACGAAGLVVKRPEQLNEVDGLILPGGESTTMRRLIDTYQFMEPLREFAAQGKPMFGTCAGLIILAKEIAGSDNPHLGLLNVVVERNSFGRQVDSFEADLTIKGLDEPFTGVFIRAPHILEAGENVEVLSEHNGRIVAAKQGQFLGCSFHPELTEDHRVTQLFVEMVEEYKQKALV

SEQ ID NO: 19 - DNA, 1329 bp, Unknown
  CDS (1)..(1329): basf-yaad-Xa-dewA-his
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatccattgaaggccgcatgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgagggatctcatcaccatcaccatcac

SEQ ID NO: 20 - protein, 443 aa, Unknown
  basf-yaad-Xa-dewA-his
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAEGSHHHHHH

SEQ ID NO: 21 - DNA, 1395 bp, Unknown
  CDS (1)..(1395): basf-yaad-Xa-rodA-his
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatctattgaaggccgcatgaagttctccattgctgccgctgtcgttgctttcgccgcctccgtcgcggccctccctcctgcccatgattcccagttcgctggcaatggtgttggcaacaagggcaacagcaacgtcaagttccctgtccccgaaaacgtgaccgtcaagcaggcctccgacaagtgcggtgaccaggcccagctctcttgctgcaacaaggccacgtacgccggtgacaccacaaccgttgatgagggtcttctgtctggtgccctcagcggcctcatcggcgccgggtctggtgccgaaggtcttggtctcttcgatcagtgctccaagcttgatgttgctgtcctcattggcatccaagatcttgtcaaccagaagtgcaagcaaaacattgcctgctgccagaactccccctccagcgcggatggcaaccttattggtgtcggtctcccttgcgttgcccttggctccatcctcggatctcatcaccatcaccatcac

SEQ ID NO: 22 - protein, 465 aa, Unknown
  basf-yaad-Xa-rodA-his
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMKFSIAAAVVAFAASVAALPPAHDSQFAGNGVGNKGNSNVKFPVPENVTVKQASDKCGDQAQLSCCNKATYAGDTTTVDEGLLSGALSGLIGAGSGAEGLGLFDQCSKLDVAVLIGIQDLVNQKCKQNIACCQNSPSSADGNLIGVGLPCVALGSILGSHHHHHH

SEQ ID NO: 23 - DNA, 1407 bp, Unknown
  CDS (1)..(1407): basf-yaad-Xa-BASF1-his
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatctattgaaggccgcatgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcctcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccaggtcaacaagcagtgcaagcagaacatcgcctgctgccagaactccccttccgacgccaccggctccctcgtcaacctcggcctcggcaacccttgcatccctgtctccctcctccatatgggatctcatcaccatcaccatcac

SEQ ID NO: 24 - protein, 469 aa, Unknown
  basf-yaad-Xa-BASF1-his
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMKFSVSAAVLAFAASVAALPQHDSAAGNGNGVGNKFPVPDDVTVKQATDKCGDQAQLSCCNKATYAGDVLTDIDEGILAGLLKNLIGGGSGSEGLGLFDQCVKLDLQISVIGIPIQDLLNQVNKQCKQNIACCQNSPSDATGSLVNLGLGNPCIPVSLLHMGSHHHHHH

SEQ ID NO: 25 - DNA, 28 bp, Unknown
  Hal570 oligonucleotide
gcgcgcccatggctcaaacaggtactga

SEQ ID NO: 26 - DNA, 28 bp, Unknown
  Hal571 oligonucleotide
gcagatctccagccgcgttcttgcatac

SEQ ID NO: 27 - DNA, 30 bp, Unknown
  Hal572 oligonucleotide
ggccatgggattaacaataggtgtactagg

SEQ ID NO: 28 - DNA, 33 bp, Unknown
  Hal573 oligonucleotide
gcagatcttacaagtgccttttgcttatattcc

SEQ ID NO: 29 - DNA, 38 bp, Unknown
  KaM416 oligonucleotide
gcagcccatcagggatccctcagccttggtaccagcgc

SEQ ID NO: 30 - DNA, 50 bp, Unknown
  KaM417 oligonucleotide
cccgtagctagtggatccattgaaggccgcatgaagttctccgtctccgc

SEQ ID NO: 31 - DNA, 45 bp, Unknown
  KaM434 oligonucleotide
gctaagcggatccattgaaggccgcatgaagttctccattgctgc

SEQ ID NO: 32 - DNA, 30 bp, Unknown
  KaM435 oligonucleotide
ccaatggggatccgaggatggagccaaggg

SEQ ID NO: 33 - DNA, 38 bp, Unknown
  KaM418 oligonucleotide
ctgccattcaggggatcccatatggaggagggagacag

SEQ ID NO: 34 - DNA, 32 bp, Unknown
  KaM464 oligonucleotide
cgttaaggatccgaggatgttgatgggggtgc

SEQ ID NO: 35 - DNA, 35 bp, Unknown
  KaM465 oligonucleotide
gctaacagatctatgttcgcccgtctccccgtcgt

(19) United States
(12) Patent Application Publication
(10) Pub. No.: US 2009/0041922 A1
(43) Pub. Date: Feb. 12, 2009

(54) Aqueous monomer emulsions containing hydrophobin

(75) Inventors: Anuelika Kühnle, Osnabrueck (DE); Christian Exner, Neustadt (DE); Claus Bollschweiler, Heidelberg (DE); Thomas Subkowski, Ladenburg (DE); Ulf Baus, Dossenheim (DE); Hans-Georg Lemaire, Limburgerhof (DE); Marvin Karos, Schwetzingen (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/988,628

(22) PCT Filed: Jul. 10, 2006
(86) PCT No.: PCT/EP2006/064040

§ 371 Date: Jan. 11, 2008

(30) Foreign Application Priority Data
Jul. 14, 2005 (DE) 10 2005 033 002.9

(51) Int. Cl. A23K 1/00; C08K 3/32; C08F 2/22; C08K 3/10

(52) U.S. Cl. 426/654; 524/706; 524/787; 524/831; 524/832; 524/834; 524/836

(57) ABSTRACT

Emulsions of hydrophobic monomers in water comprising inorganic particles as Pickering emulsifiers, and hydrophobin; and also the preparation and use of the emulsions are described.

The invention relates to emulsions of hydrophobic monomers in water comprising inorganic particles as Pickering emulsifiers, and hydrophobin, and to a process for the preparation of these emulsions, where the monomers are dispersed in water in the presence of inorganic particles which act as Pickering emulsifier, wherein hydrophobin is co-used.

The invention also relates to the use of hydrophobin in the preparation of emulsions of hydrophobic monomers in water, and to a process for the suspension polymerization of hydrophobic monomers in water with co-use of inorganic particles as Pickering emulsifiers, wherein hydrophobin is co-used.

In addition, the invention relates to the use of the emulsions as feed material in a suspension polymerization.

Finally, the invention relates to a process for producing expandable or expanded thermoplastic polymer particles with co-use of a propellant, wherein the polymer particles are prepared using the specified process for suspension polymerization, and to the expandable or expanded polymer particles obtainable by this process, and to the use of these expandable or expanded polymer particles for producing foams or foam moldings.

Emulsions of hydrophobic monomers in water are used as starting material, inter alia, in polymerizations. For example, an emulsion of styrene in water can be polymerized by suspension polymerization to give polystyrene particles. If propellants are co-used here, propellant-containing polymer particles are obtained which are expandable or expanded depending on the pressure and temperature conditions and from which it is possible, inter alia, to produce foams and foam moldings.

The specified emulsions of monomers in water are in many cases—like other oil-in-water emulsions too—stabilized by emulsifiers, which prevent coalescence of the monomer droplets distributed in the water phase. The emulsifiers used are usually organic compounds, in particular surfactants (e.g. soaps, alkylsulfonates, fatty alcohol compounds). However, they have a tendency toward foaming, and the foam can make handling the emulsion significantly more difficult and, for example, make conveyance using pumps impossible.

So-called Pickering emulsifiers are known in particular from the suspension polymerization of aqueous monomer emulsions, but also from other fields of use. Such emulsifiers are understood as meaning water-insoluble inorganic compounds, for example magnesium pyrophosphate or calcium phosphate. They are used in finely distributed form in the emulsion and prevent the polymerizing monomer droplets sticking together during the polymerization. They have a much lesser tendency toward foaming and can be separated off after the polymerization is complete by washing out. However, the effectiveness of the Pickering emulsifiers is not always satisfactory, i.e. it is not always possible to prepare a stable emulsion with them. For example, the wettability of the Pickering emulsifier particles is not always such that they are interface-active.

DE 42 20 225 A1 discloses the preparation of bead-like expandable styrene polymers by polymerization of styrene in aqueous suspension with the addition of propellant, where the suspension stabilizer used is a mixture of magnesium pyrophosphate, alkylsulfonates as extender, and an alkali(ne earth) metal carboxylate.

Hydrophobins are small proteins of about 100 to 150 amino acids which are characteristic of filamentous fungi, for example Schizophyllum commune. They generally have 8 cysteine units. Hydrophobins can be isolated from natural sources. However, it is also possible to synthesize hydrophobins which do not occur naturally by means of chemical and/or biotechnological preparation processes.

Hydrophobins have a marked affinity to interfaces and are therefore suitable for coating surfaces. Thus, for example, Teflon® can be coated by means of hydrophobins to give a hydrophilic surface.

Hydrophobins can be isolated from natural sources. The earlier German patent application file ref. DE 102005007480.4 dated Feb. 17, 2005, which was unpublished at the priority date of the present invention, discloses a preparation process for hydrophobins.

In the prior art, the use of hydrophobins has been proposed for various applications.

WO 01/57528 discloses the coating of windows, contact lenses, biosensors, medical instruments, containers for carrying out experiments or for storage, hulls of ships, solid particles or frames or bodywork of cars with a solution comprising hydrophobins at a temperature of from 30 to 80° C.

WO 01/57066 describes a specific process for coating with hydrophobin.

WO 03/53383 discloses the use of hydrophobin for treating keratin materials in cosmetic applications.

WO 03/10331 discloses a sensor coated with hydrophobin, for example a measurement electrode, to which further substances, e.g. electroactive substances, antibodies or enzymes, are not covalently bonded.

WO 96/41882 proposes, on page 9-10, the use of hydrophobins as emulsifiers, thickeners, surface-active substances, for hydrophilicizing hydrophobic surfaces, for improving the water resistance of hydrophilic substrates, for preparing oil-in-water emulsions or water-in-oil emulsions. In addition, the use in foods for improving their storability, pharmaceutical applications, such as the preparation of ointments or creams, and also cosmetic applications such as skin protection or the preparation of hair shampoos or hair rinses are proposed.

It was the object to provide monomer-in-water emulsions with an alternative composition. The emulsion should not have a tendency toward foaming and should be stable for several hours, i.e. not exhibit any separation. Ideally, it should be able to be polymerized by suspension polymerization.

Accordingly, the emulsions, processes, uses and polymer particles specified at the start have been found. Preferred embodiments of the invention are given in the dependent claims. All of the pressures given are absolute pressures.

Hydrophobin

The emulsions according to the invention comprise hydrophobin. For the purposes of the present invention, the term “hydrophobin” should preferably be understood as meaning proteins of the general structural formula (I)

Xₙ-C¹-X₁₋₅₀-C²-X₀₋₅-C³-X₁₋₁₀₀-C⁴-X₁₋₁₀₀-C⁵-X₁₋₅₀-C⁶-X₀₋₅-C⁷-X₁₋₅₀-C⁸-Xₘ (I)

where X can be any of the 20 naturally occurring amino acids (Phe, Leu, Ser, Tyr, Cys, Trp, Pro, His, Gln, Arg, Ile, Met, Thr, Asn, Lys, Val, Ala, Asp, Glu, Gly). Here, X may in each case be identical or different. The indices alongside X are here in each case the number of amino acids. C is cysteine, alanine, serine, glycine, methionine or threonine, where at least four of the radicals named as C are cysteine, and the indices n and m, independently of one another, are natural numbers from 0 to 500, preferably from 15 to 300.

The polypeptides according to formula (I) are also characterized by the property that, at room temperature, following coating of a glass surface, they bring about an increase in the contact angle of a drop of water of at least 20°, preferably at least 25° and particularly preferably 30°, in each case compared with the contact angle of a water drop of identical size with the uncoated glass surface.

The amino acids named as C¹ to C⁸ are preferably cysteines; they can, however, also be replaced by other amino acids of similar spatial arrangement, preferably by alanine, serine, threonine, methionine or glycine. However, at least four, preferably at least 5, particularly preferably at least 6 and in particular at least 7, of the positions C¹ to C⁸ should consist of cysteines. Cysteines may be present in the proteins according to the invention either in reduced form, or form disulfide bridges with one another. Particular preference is given to the intramolecular formation of C—C bridges, in particular those with at least one, preferably 2, particularly preferably 3 and very particularly preferably 4, intramolecular disulfide bridges. In the case of the above-described replacement of cysteines by amino acids of similar spatial arrangement, such C positions are advantageously exchanged in pairs which can form intramolecular disulfide bridges with one another.

If cysteines, serines, alanines, glycines, methionines or threonines are also used in the positions referred to as X, numbering of the individual C positions in the general formulae can change accordingly.

Preferably, hydrophobins of the general formula (II)

Xₙ-C¹-X₃₋₂₅-C²-X₀₋₂-C³-X₅₋₅₀-C⁴-X₂₋₃₅-C⁵-X₂₋₁₅-C⁶-X₀₋₂-C⁷-X₃₋₃₅-C⁸-Xₘ (II)

are used for carrying out the present invention, where X, C and the indices alongside X and C have the above meaning, but the indices n and m are, independently of one another, natural numbers from 0 to 300. Preferably, the proteins are further characterized by the abovementioned contact angle change.

Particular preference is given to using hydrophobins of the general formula (III)

Xₙ-C¹-X₅₋₉-C²-C³-X₁₁₋₃₉-C⁴-X₂₋₂₃-C⁵-X₅₋₉-C⁶-C⁷-X₆₋₁₈-C⁸-Xₘ (III)

where X, C and the indices alongside X and C have the above meaning, the indices n and m are numbers from 0 to 200. Preferably, the proteins are further characterized by the abovementioned contact angle change. It is likewise preferable that at least 6 of the radicals named as C are cysteine. It is particularly preferred that all of the radicals C are cysteine.

The radicals Xₙ and Xₘ may be peptide sequences which are naturally linked to a hydrophobin. However, it is also possible for one or both radicals to be peptide sequences which are naturally not linked to a hydrophobin. These are also understood as meaning those radicals Xₙ and/or Xₘ in which a peptide sequence which occurs naturally in a hydrophobin is extended by a peptide sequence which does not occur naturally in a hydrophobin.

If Xₙ and/or Xₘ are peptide sequences which are naturally not linked to a hydrophobin, such sequences are generally at least 20, preferably at least 35, particularly preferably at least 50 and very particularly preferably at least 100 amino acids in length. Such a radical which is naturally not linked to a hydrophobin will also be referred to below as fusion partners. This expression is intended to mean that the proteins can consist of at least one hydrophobin part and a fusion partner which do not occur together in this form in nature.

The fusion partner can be chosen from a large number of proteins. It is also possible for a plurality of fusion partners to be linked to a hydrophobin part, for example on the amino terminus (Xₙ) and on the carboxy terminus (Xₘ) of the hydrophobin part. However, it is also possible, for example, for two fusion partner parts to be linked to one position (Xₙ or Xₘ) of the protein according to the invention.

Particularly suitable fusion partner parts are proteins which occur naturally in microorganisms, in particular in E. coli or Bacillus subtilis. Examples of such fusion partner parts are the sequences yaad (SEQ ID NO: 15 and 16), yaae (SEQ ID NO: 17 and 18), and thioredoxin. Also highly suitable are fragments or derivatives of these specified sequences which comprise only part, preferably 70-99%, particularly preferably 80-98%, of said sequences, or in which individual amino acids, or nucleotides have been altered compared with the specified sequence, the percentages given in each case referring to the number of amino acids.

The proteins used according to the invention can also be modified in their polypeptide sequence, for example by glycosilation, acetylation or else through chemical crosslinking, for example with glutardialdehyde.

One property of the proteins used according to the invention is the change in surface properties if the surfaces are coated with the proteins. The change in the surface properties can be determined experimentally by measuring the contact angle of a drop of water before and after coating the surface with the protein and calculating the difference between the two measurements.

The procedure of measuring the contact angles is known in principle to the person skilled in the art. The measurements refer to room temperature and to water drops of 5 μl. The precise experimental conditions for a method, suitable by way of example, for measuring the contact angle are laid down in the experimental section. Under the conditions specified therein, the proteins used according to the invention have the property to increase the contact angle by at least 20°, preferably at least 25°, particularly preferably at least 30°, in each case compared with the contact angle of a water drop identical in size with the uncoated glass surface.

In the hydrophobin part of the hydrophobins known to date the positions of the polar and nonpolar amino acids are preserved, which is evident from a characteristic hydrophobicity plot. Differences in the biophysical properties and in the hydrophobicity led to the classification of the hydrophobins known to date into two classes, I and II (Wessels et al. 1994, Ann. Rev. Phytopathol., 32, 413-437).

The assembled membranes from class I hydrophobins are to a large extent insoluble (even to 1% Na dodecyl sulfate (SDS) at elevated temperature) and can only be dissociated again using concentrated trifluoroacetic acid (TFA), or formic acid. In contrast to this, the assembled forms of class II hydrophobins are less stable. They can be dissolved again using just 60% strength ethanol, or 1% SDS (at room temperature).

A comparison of the amino acid sequences shows that the length of the region between cysteine C³ and C⁴ in the case of class II hydrophobins is significantly shorter than in the case of class I hydrophobins. Class II hydrophobins also have more charged amino acids than class I.

Particularly preferred hydrophobins for carrying out the present invention are the hydrophobins of the type dewA, rodA, hypA, hypB, sc3, basf1 and basf2, which are characterized structurally in the sequence protocol which follows. These may also only be parts or derivatives thereof. It is also possible for two or more hydrophobin parts, preferably 2 or 3, of identical or different structure to be linked together and linked to a corresponding suitable polypeptide sequence which is naturally not bonded to a hydrophobin.

Of particular suitability for carrying but the present invention are also the fusion proteins with the polypeptide sequences depicted in SEQ ID NO: 20, 22, 24, and the nucleic acid sequences which encode for these, in particular the sequences according to SEQ ID NO: 19, 21, 23. Proteins which arise starting from the polypeptide sequences depicted in SEQ ID NO: 22, 22 or 24 as a result of exchange, insertion or deletion of at least one, up to 10, preferably 5, particularly preferably 5%, of all amino acids and which still have at least 50% of the biological property of the starting proteins are also particularly preferred embodiments. Biological property of the proteins is understood here as meaning the increase in the contact angle by at least 20° as already described.

The hydrophobin is preferably used in an amount of from 20 to 150, in particular 30 to 100 and particularly preferably 40 to 90 ppmw (parts per million by weight), based on the total amount of the emulsion. For styrene as monomer, the amount of hydrophobin is, for example, 20 to 100, in particular 40 to 90, ppmw, based on the emulsion.

The hydrophobin can be added to the emulsion as it is, or in dissolved or dispersed form in a solvent or dispersant. A suitable solvent or dispersant is water. The hydrophobin content of such a solution or dispersion is generally 0.3 to 1.2, preferably 0.35 to 0.5% by weight. Preferably, the hydrophobin is added in the form of an aqueous solution.

Preparation of the Hydrophobin

The hydrophobins used according to the invention can be prepared chemically by known processes of peptide synthesis, for example by solid-phase synthesis in accordance with Merrifield.

Naturally occurring hydrophobins can be isolated from natural sources using suitable methods. By way of example, reference may be made here to Wösten et al., Eur. J Cell Bio. 63, 122-129 (1994) or WO 96/41882.

Fusion proteins can preferably be prepared by genetic engineering processes in which one nucleic acid sequence which encodes for the fusion partner and one nucleic acid sequence which encodes for the hydrophobin part, in particular DNA sequence, are combined so that the desired protein is generated in a host organism through gene expression of the combined nucleic acid sequence. Such a preparation process is disclosed in our earlier application file ref. DE 102005007480.4 mentioned at the start.

Suitable host organisms (production organisms) for the specified preparation process may here be prokaryotes (including the Archaea) or eukaryotes, in particular bacteria including halobacteria and methanococci, fungi, insect cells, plant cells and mammal cells, particularly preferably Escherichia coli, Bacillus subtilis, Bacillus megaterium, Aspergillus oryzea, Aspergillus nidulans, Aspergillus niger, Pichia pastoris, Pseudomonas spec., lactobacillae, Hansenula polymorpha, Trichoderma reesei, SF9 (or related cells) etc.

It is also possible to use expression constructs comprising regulative nucleic acid sequences under genetic control, a nucleic acid sequence which encodes for a polypeptide used according to the invention, and also vectors comprising at least one of these expression constructs.

Preferably, constructs used comprise a promoter 5′-upstream of the particular coding sequence and a terminator sequence 3′-downstream, and, if appropriate, further customary regulative elements, in each case operatively linked to the coding sequence.

An “operative linkage” is understood as meaning the sequential arrangement of promoter, coding sequence, terminator and, if appropriate, further regulative elements in such a way that each of the regulative elements can perform its function as intended during the expression of the coding sequence.

Examples of operatively linkable sequences are targeting sequences and enhancers, polyadenylation signals and the like. Further regulative elements comprise selectable markers, amplification signals, replication origins and the like. Suitable regulatory sequences are described, for example, in Goeddel, Gene Expression Technology: Methods in Enzymology 185, Academic Press, San Diego, Calif. (1990).

In addition to these regulation sequences, the natural regulation of these sequences may still be present before the actual structure genes and, if appropriate, have been genetically modified so that the natural regulation has been switched off and expression of the genes has been increased.

A preferred nucleic acid construct advantageously also comprises one or more of the “enhancer” sequences already mentioned, functionally linked to the promoter, which allow increased expression of the nucleic acid sequence. Additional advantageous sequences, such as further regulatory elements or terminators, can also be inserted at the 3′-end of the DNA sequences.

The nucleic acids may be present in one or more copies in the construct. In the construct, further markers, such as genes complementing antibiotic resistances or auxotrophs, if appropriate for selection on the construct, may also be present.

Advantageous regulation sequences for the process are present, for example, in promoters such as cos, tac, trp, tet, trp, tet, lpp, lac, lpp, lac, laclq-T7 , T5, T3, gal, trc, ara, rhaP(rhaPBAD) SP6, lambda-PR or imlambda-P promoter, which are advantageously used in gram-negative bacteria. Further advantageous regulation sequences are present, for example, in the gram-positive promoters amy and SP02, in the yeast or fungi promoters ADC1, MFalpha, AC, P-60, CYC1, GAPDH, TEF, rp28, ADH.

It is also possible to use artificial promoters for the regulation.

For expression in a host organism, the nucleic acid construct is advantageously inserted into a vector, such as, for example, a plasmid or a phage, which allows optimum expression of the genes in the host. Apart from plasmids and phages, vectors are also understood as meaning all other vectors known to the person skilled in the art, thus e.g. viruses, such as SV40, CMV, baculovirus and adenovirus, transposons, IS elements, phasmids, cosmids, and linear or circular DNA, and also the agrobacterium system.

These vectors can be replicated autonomously in the host organism or be chromosomally replicated. These vectors represent a further embodiment of the invention. Suitable plasmids are, for example, in E. coli pLG338, pACYC184, pBR322, pUC18, pUC19, pKC30, pRep4, pHS1, pKK223-3, pDHE19.2, pHS2, pPLc236, pMBL24, pLG200, pUR290, pIN-III″3-B1, tgt11 or pBdCl, in streptomyces pIJ101, pIJ364, pIJ702 or pIJ361, in bacillus pUB110, pC194 or pBD214, in corynebacterium pSA77 or pAJ667, in fungi pALS1, pIL2 or pBB116, in yeasts 2alpha, pAG-1, YEp6, YEp13 or pEMBLYe23 or in plants pLGV23, pGHlac+, pBIN19, pAK2004 or pDH51. The specified plasmids represent a small selection of the possible plasmids. Further plasmids are known to the person skilled in the art and can be found, for example, in the book Cloning Vectors (Eds. Pouwels P. H. et al. Elsevier, Amsterdam-New York-Oxford, 1985, ISBN 0 444 904018).

Advantageously, the nucleic acid construct for expressing the further genes present additionally also comprises 3′- and/or 5′-terminal regulatory sequences for increasing the expression which are chosen for optimum expression depending on the host organism and gene or genes chosen.

These regulatory sequences should permit the targeted expression of the genes and protein expression. Depending on the host organism, this can mean, for example, that the gene is expressed or overexpressed only after induction, or that it is expressed and/or overexpressed immediately.

The regulatory sequences and factors can here preferably have a positive influence, and thereby increase, the gene expression of the inserted genes. Thus, an increase in the regulatory elements can advantageously take place on the transcription level by using strong transcription signals such as promoters and/or “enhancers”. In addition, however, an increase in the translation is also possible by, for example, improving the stability of the mRNA.

In a further embodiment of the vector, the vector comprising the nucleic acid construct or the nucleic acid can also advantageously be inserted into the microorganisms in the form of a linear DNA and be integrated into the genome of the host organism via heterologous or homologous recombination. This linear DNA can consist of a linearized vector such as a plasmid or only of the nucleic acid construct or the nucleic acid.

For optimum expression of heterologous genes in organisms, it is advantageous to change the nucleic acid sequences to correspond to the specific “codon usage” used in the organism. The “codon usage” can be determined easily using computer evaluations of other known genes of the organism in question.

An expression cassette is prepared by fusing a suitable promoter with a suitable coding nucleotide sequence and a terminator or polyadenylation signal. For this purpose, use is made of customary recombinant and cloning techniques, as described, for example, in T. Maniatis, E. F. Fritsch and J. Sambrook, Molecular Cloning: A Laboratory Manual, Cold Spring Harbor Laboratory, Cold Spring Harbor, N.Y. (1989), and in T. J. Silhavy, M. L. Berman and L. W. Enquist, Experiments with Gene Fusions, Cold Spring Harbor Laboratory, Cold Spring Harbor, N.Y. (1984) and in Ausubel, F. M. et al., Current Protocols in Molecular Biology, Greene Publishing Assoc. and Wiley Interscience (1987).

For expression in a suitable host organism, the recombinant nucleic acid construct or gene construct is advantageously inserted into a host-specific vector which allows optimum expression of the genes in the host. Vectors are well known to the person skilled in the art and can be found, for example, in “Cloning Vectors” (Pouwels P. H. et al., Ed. Elsevier, Amsterdam-New York-Oxford, 1985).

With the help of the vectors it is possible to prepare recombinant microorganisms which are, for example, transformed with at least one vector and can be used for producing the proteins used according to the invention. The recombinant constructs described above are advantageously inserted into a suitable host system and expressed. In this connection, preference is given to using customary cloning and transfection methods known to the person skilled in the art, such as, for example, coprecipitation, protoplast fusion, electroporation, retroviral transfection and the like, in order to cause the specified nucleic acids be express in the particular expression system. Suitable systems are described, for example, in Current Protocols in Molecular Biology, F. Ausubel et al., Ed. Wiley Interscience, New York 1997, or Sambrook et al. Molecular Cloning: A Laboratory Manual. 2nd edition, Cold Spring Harbor Laboratory, Cold Spring Harbor Laboratory Press, Cold Spring Harbor, N.Y., 1989.

It is also possible to prepare homologously recombinant microorganisms. For this purpose, a vector is prepared which comprises at least one section of a gene to be used according to the invention or of a coding sequence in which, if appropriate, at least one amino acid deletion, addition or substitution has been introduced in order to change, e.g. functionally disrupt, the sequence (“knockout” vector). The inserted sequence can, for example, also be a homolog from a related microorganism or be derived from a mammal source, yeast source or insect source. The vector used for the homologous recombination can alternatively be designed in such a way that the endogenous gene is mutated or changed in some other way during homologous recombination, but still codes the functional protein (e.g. if the upstream regulatory region can be changed in such a way that the expression of the endogenous protein is changed as a result). The changed section of the gene used according to the invention is in the homologous recombination vector. The construction of suitable vectors for the homologous recombination is described, for example, in Thomas, K. R. and Capecchi, M. R. (1987) Cell 51: 503.

Suitable recombinant host organisms for the nucleic acid used according to the invention or the nucleic acid construct are in principle all prokaryotic or eukaryotic organisms. The host organisms used are advantageously microorganisms such as bacteria, fungi or yeasts. Gram-positive or gram-negative bacteria are advantageously used, preferably bacteria of the families enterobacteriaceae, pseudomonadaceae, rhizobiaceae, streptomycetaceae or nocardiaceae, particularly preferably bacteria of the genuses Escherichia, Pseudomonas, Streptomyces, Nocardia, Burkholderia, Salmonella, Agrobacterium or Rhodococcus.

The organisms used in the preparation process for fusion proteins are grown or cultivated in the manner known to the person skilled in the art depending on the host organism. Microorganisms are generally grown in a liquid medium which comprises a carbon source mostly in the form of sugars, a nitrogen source mostly in the form of organic nitrogen sources such as yeast extract or salts such as ammonium sulfate, trace elements such as iron salts, manganese salts and magnesium salts, and, if appropriate, vitamins, at temperatures between 0 and 100° C., preferably between 10 to 60° C. under oxygen. Here, the pH of the nutrient liquid can be kept at a fixed value, i.e. be regulated or not regulated during the cultivation. The cultivation can be batchwise, semibatchwise or continuous. Nutrient substances can be initially introduced at the start of the fermentation or can be fed in afterwards semicontinuously or continuously. The enzymes can be isolated from the organisms by the process described in the examples or be used as raw extract for the reaction.

Proteins used according to the invention or functional, biologically active fragments thereof can be prepared by means of a recombinant process in which a protein-producing microorganism is cultivated, if appropriate expression of the proteins is induced and these proteins are isolated from the culture. The proteins can thus also be produced on an industrial scale if desired. The recombinant microorganism can be cultivated and fermented by known processes. Bacteria can be multiplied, for example, in TB or LB medium and at a temperature of from 20 to 40° C. and a pH of from 6 to 9. Specifically, suitable cultivation conditions are described, for example, in T. Maniatis, E. F. Fritsch and J. Sambrook, Molecular Cloning: A Laboratory Manual, Cold Spring Harbor Laboratory, Cold Spring Harbor, N.Y. (1989).

If the proteins used according to the invention are not secreted into the culture medium, the cells are then disrupted and the product is obtained from the lysate by known protein isolation processes. The cells can be disrupted as desired by high-frequency ultrasound, by high pressure, such as, for example, in a French pressure cell, by osmolysis, by the action of detergents, lytic enzymes or organic solvents, by homogenizers or by combining two or more of the processes listed.

Purification of the proteins used according to the invention can be achieved using known chromatographic methods, such as molecular sieve chromatography (gel filtration), such as Q-sepharose chromatography, ion-exchange chromatography and hydrophobic chromatography, and with other customary methods, such as ultrafiltration, crystallization, salting out, dialysis and native gel electrophoresis. Suitable methods are described, for example, in Cooper, F. G., Biochemische Arbeitsmethoden [Biochemical working methods], Verlag Water de Gruyter, Berlin, New York or in Scopes, R., Protein Purification, Springer Verlag, New York, Heidelberg, Berlin.

It may be advantageous, for isolating the recombinant protein, to use vector systems or oligonucleotides which extend the cDNA by certain nucleotide sequences and thus code for modified proteins or fusion proteins which serve, for example, for easier purification. Such suitable modifications comprise so-called “tags” acting as anchors, such as, for example, the modification known as hexahistidine anchor, or epitopes which can be recognized as antigens by antibodies (described, for example, in Harlow, E. and Lane, D., 1988, Antibodies: A Laboratory Manual. Cold Spring Harbor (N.Y.) Press). Further suitable tags are, for example, HA, calmodulin-BD, GST, MBD; chitin-BD, steptavidin-BD Avi Tag, Flag Tag, T7 etc. These anchors can serve to attach the proteins to a fixed support, such as, for example, a polymer matrix, which can be packed in a chromatography column, or can be used on a microtiter plate or another carrier. The corresponding purification protocols are available from the commercial affinity tag suppliers.

The proteins prepared as described can either be used directly as fusion proteins or else after cleavage and separation of the fusion partner as “pure” hydrophobins.

If separation of the fusion partners is intended, it is advisable to incorporate a potential cleavage site (specific recognition site for proteases) into the fusion protein between hydrophobin part and fusion partner part. Suitable cleavage sites are, in particular, those peptide sequences which otherwise occur neither in the hydrophobin part nor in the fusion partner part, which can be ascertained easily using bioinformatic tools. Of particular suitability are, for example, BrCN cleavage on methionine, or protease-mediated cleavage with factor Xa, enterokinase, thrombin, TEV cleavage (tobacca etch virus protease).

Monomers

Suitable monomers for the emulsion according to the invention are in principle all hydrophobic monomers. Here, hydrophobic means that when the monomers are combined with water, two phases form, i.e. the monomers are not miscible with water or are only miscible to a small extent.

Preferably, the monomer is styrene, it being possible, if appropriate, to co-use comonomers in amounts of up to 50% by weight, based on the total amount of monomer. Such comonomers are, for example, α-methylstyrene, ring-halogenated styrenes, ring-alkylated styrenes, acrylonitrile, esters of acrylic acid or methacrylic acid of alcohols having 1 to 8 carbon atoms, N-vinyl compounds, such as vinylcarbazole and also small amounts of compounds with two polymerizable double bonds, e.g. butadiene, divinylbenzene or butanediol diacrylate. Very particular preference is given to using styrene on its own.

Accordingly, the emulsions according to the invention are preferably notable for the fact that the monomer is styrene, it being possible to co-use comonomers which are chosen from α-methylstyrene, ring-halogenated styrenes, ring-alkylated styrenes, acrylonitrile, esters of acrylic acid or methacrylic acid of C₁₋₈-alcohols, N-vinyl compounds, butadiene, divinylbenzene or butanediol diacrylate.

The volume ratio of monomer to water in the emulsion according to the invention (phase volume ratio) depends, inter alia, on the monomer used and is generally 0.75:1 to 1.5:1, in particular 0.9:1 to 1.4:1 and particularly preferably 1:1 to 1.4:1. For styrene as monomer, the volume ratio of styrene to water is, for example, 1:1 to 1.5:1, preferably 1.1:1 to 1.4:1 and in particular 1.2:1 to 1.3:1.

Inorganic Particles

According to the invention, the emulsion comprises inorganic particles as Pickering emulsifiers. Such particles are known, for example from Aveyard et al., Adv. Coll. Interf. Sci. 100-102 (2003), 503-546.

The inorganic particles are preferably chosen from particles comprising magnesium pyrophosphate (MPP), barium sulfate, zinc oxide and calcium phosphate. Of these, particles comprising magnesium pyrophosphate are preferred, in particular for styrene as monomer.

These particles (Pickering emulsifiers) are prepared by customary reactions of inorganic chemistry, i.e. for example by precipitation from a solution or by solid-state reactions. Preferably, the particles are prepared directly prior to use by combining suitable aqueous solutions or by adding an aqueous solution to a solid, in which case the particles precipitate out as sparingly soluble compound.

For example, MPP particles can be prepared by combining an aqueous solution of an alkali metal pyrophosphate with at least the stoichiometrically required amount of a magnesium salt, it being possible for the magnesium salt to be in solid form or in aqueous solution. The MPP is particularly preferably prepared by combining aqueous solutions of sodium pyrophosphate (Na₄P₂O₇) and magnesium sulfate (MgSO₄.7 H₂O). Preference is given to initially introducing dissolved sodium pyrophosphate and adding the magnesium sulfate solution. The magnesium salt is added in at least the stoichiometrically required amount, preferably in exactly the stoichiometric amount. In particular, no excess of alkali metal pyrophosphate should be present.

The MPP is particularly preferably not prepared in the presence of the total amount of aqueous phase of the emulsion. It is advantageous to use less than half of the total amount of water used to prepare the emulsion. For example, an approximately 20% strength by weight magnesium sulfate solution can be added to an approximately 3% strength by weight sodium pyrophosphate solution. Further details are given in DE 42 20 225 A1.

The particle size of the inorganic particles (Pickering emulsifiers) is controlled by the precipitation conditions and is usually 10 nm to 10 μm, preferably 10 nm to 1 μm and particularly preferably 20 to 100 nm, expressed as number-average particle diameter d₅₀ (in each case 50% of the particles are smaller or larger than the d₅₀ diameter). Preferably, the particles have a nonspherical shape.

The inorganic particles are generally used in an amount of from 500 to 1000, preferably 600 to 900 and in particular 700 to 800 ppmw, based on the emulsion. For styrene as monomer, the amount is, for example, usually 600 to 900, preferably 700 to 800 ppmw, based on the emulsion.

The inorganic particles can be added to the emulsion as they are, or preferably suspended in a suspending agent. A suitable suspending agent is water. Preference is given to directly using the aqueous suspension obtained during the preparation of the particles. Such a suspension comprises, for example, 1 to 2% by weight, preferably 1.7 to 1.9% by weight, of the inorganic particles. The use of a freshly prepared suspension is particularly preferred.

Other Constituents of the Emulsion

Besides water, monomers, inorganic particles (Pickering emulsifiers) and hydrophobin, the emulsion according to the invention can also comprise further constituents.

For example, a propellant can be added if the emulsion according to the invention is to be subjected to a polymerization and propellant-containing, expandable or expanded polymer particles are to be prepared in the process. Suitable propellants are, in particular, physical propellants, such as carbon dioxide, aliphatic hydrocarbons having 2 to 7 carbon atoms, alcohols, ketones, ethers, halogenated hydrocarbons or water, or mixtures thereof. If, for example, a styrene-in-water emulsion is to be polymerized to give propellant-containing polystyrene particles, preference is given to using propane, isobutane, n-butane, isopentane, neopentane, n-pentane, hexane, carbon dioxide and mixtures thereof.

If a propellant is added, its amount is usually 1 to 10% by weight, preferably 3 to 8% by weight, based on the amount of monomer.

It is not, however, absolutely necessary to add a propellant since, as is known, propellant-containing polymer particles can also be prepared by other processes, for example by impregnation of the finished polymer particles with the propellant under increased pressure and elevated temperature, during which the propellant diffuses into the softened particles, or in the so-called extrusion process by mixing the propellant into a polymer melt in an extruder, and granulating the discharged melt.

Furthermore, other customary additives can be added to the emulsion, e.g. nucleating agents, plasticizers, flame retardants, antistats, antioxidants, UV absorbers, IR absorbers such as soot and graphite, aluminum powder, soluble and insoluble dyes and pigments. The additives are used in the amounts customary for this purpose. Suitable nucleating agents in the case of styrene as monomer or polystyrene as polymer particles are, for example, talc and/or waxes, and also soot, graphite and fumed silicas, in amounts of, in total, 0.05 to 30% by weight, based on the amount of monomer. Preferred plasticizers are mineral oils, oligomeric styrene polymers and phthalates in amounts of, in total, 0.05 to 10% by weight, based on the amount of monomer.

However, it is also possible not to add these additives to the emulsion, but only at a later time, for example to the polymer particles obtained.

Furthermore, the emulsion can comprise other, organic emulsifiers (surfactants), e.g. alkylsulfonates. These include alkali metal salts of dodecylbenzenesulfonic acid or alkali metal salts of a mixture of C₁₂₋₁₇-alkylsulfonic acids, e.g. a mixture of predominantly secondary sodium alkylsulfonates of average chain length C₁₅ which comprises up to 0.2% by weight of organically bonded chlorine (commercial product Mersolat® K30 from Bayer). However, such other organic emulsifiers are preferably not co-used to prevent undesired foaming of the emulsion.

Accordingly, the emulsions according to the invention preferably comprise no organic emulsifiers or surfactants.

Preparation of the Emulsion

The emulsion is prepared batchwise or continuously in the usual manner by mixing together (dispersing) water, monomer, Pickering emulsifiers, hydrophobin and, if appropriate, further constituents. In the process, the feed materials can be added together or separately from one another, at a single time or successively, in one go, batchwise or in several portions or continuously along a mathematical function, it being possible for this function to be, for example, linear, increasing, decreasing, exponential or graduated.

Preferably, the hydrophobin is initially introduced as solution and the Pickering emulsifier—preferably as freshly prepared aqueous suspension—is added; then, if required, water is added in order to establish the monomer/water ratio, and finally the monomer is added. The mixture obtained is mixed.

The mixing is carried out in a manner known per se, e.g. by stirring, shaking or turbulent mixing. Depending on the type and amount of the feed materials used and the desired diameter of the monomer droplets in the emulsion, simple stirrers (e.g. magnetic stirrer, paddle stirrer, etc.) may be sufficient, which are operated at 500 to 1000, preferably 600 to 800, revolutions per minute (rpm). However, it is also possible to use high-speed stirrers, which are typically operated at 6000 to 10 000, in particular 9000 to 10 000 rpm, e.g. the Ultra-Turrax® from IKA.

Alternatively, it is also possible to mix by other mixing operations, for example by spraying the monomer into the water or vice versa, by vibrations and cavitation in the mixture (e.g. ultrasound), by emulsification centrifuges, colloid mills or homogenizers.

Mixing can be carried out in any container suitable for this purpose, in the simplest case this is a stirred reactor or round-bottomed flask. Stirred-reactor cascades, tubular reactors, static or dynamic mixers can also be used. If required, flow disrupters may be attached in order to improve mixing.

The mixing time for a low input of energy is in most cases 1 to 20 hours, preferably 5 to 15 hours. In the case of a high input of energy, the mixing generally lasts 60 to 300 sec, preferably 60 to 120 sec. The temperature during the preparation of the emulsion is usually 20 to 80° C., preferably 20 to 25° C.; the pressure is usually 1 to 3 bar, preferably 1 to 2 bar. Particularly in the case of monomers with a low boiling point or high vapor pressure, it may also be sensible to work at lower temperatures and/or higher pressure.

Mixing time, pressure and temperature are governed, inter alia, by the type and amount of the feed materials used and the desired monomer droplet diameter.

Properties of the Emulsion and Further Subject Matters of the Invention

The emulsion according to the invention consists of water as continuous phase and the monomer droplets as dispersed phase. The diameter of the monomer droplets can vary within wide limits depending on the type and amount of the feed materials and the conditions during mixing and is usually 100 to 2000 μm, preferably 800 to 1200 μm, particularly preferably 900 to 1000 μm, expressed as number-average droplet diameter d₅₀ (in each case 50% of the particles are smaller or larger than the d₅₀ diameter).

The emulsions are stable over a prolonged period, e.g. several hours, and do not have a tendency toward foam formation.

In a preferred embodiment, the emulsions according to the invention are notable for the fact that the monomer is styrene, the inorganic particles comprise magnesium pyrophosphate and the hydrophobin is the one described in this description in SEQ ID NO: 19.

The invention also provides the above-described process for the preparation of the emulsions according to the invention, where the monomers are dispersed in water in the presence of inorganic particles which act as Pickering emulsifier, wherein hydrophobin is co-used.

Preferably, this process is notable for the fact that the emulsion has at least one of the features of claims 1 to 8.

The invention further provides the use of hydrophobin in the preparation of emulsions of hydrophobic monomers in water. This use is preferably notable for the fact that the emulsion has at least one of the features of claims 1 to 8.

Suspension Polymerization to Give Polymer Particles

It has already been mentioned at the beginning that the emulsions according to the invention can be used as feed material in a suspension polymerization. This use is likewise provided by the invention.

The invention also comprises a process for the suspension polymerization of hydrophobic monomers in water with co-use of inorganic particles as Pickering emulsifiers, wherein hydrophobin is co-used. This process is preferably notable for the fact that the feed material used is an emulsion according to the invention as defined in claims 1 to 8.

Processes for suspension polymerization are known to the person skilled in the art, e.g. from the Kunststoff-Handbuch [Plastics handbook], volume V Polystyrene, Hanser-Verlag Munich. As a rule, customary polymerization initiators which are soluble in the monomers are used. Such initiators are, for example, styrene-soluble compounds such as tert-butyl perbenzoate or dibenzoyl peroxide. They are usually used in amounts of from 0.001 to 10% by weight, based on the amount of monomer.

Furthermore, molecular weight regulators such as tert-dodecyl mercaptan or dimeric α-methylstyrene can be co-used, usually in amounts of from 0.001 to 0.01% by weight, based on the monomers. Customary protective colloids can also be used, for example cellulose derivatives, polyvinyl alcohols, polyacrylic acids, polyacrylamides or polyvinylpyrrolidones. They are used in customary amounts. However, preferably no such protective colloids are co-used.

The temperature during the suspension polymerization is usually 0 to 200° C., preferably 50 to 150° C. The pressure is generally 0.1 mbar to 50 bar, preferably 0.8 bar to 20 bar.

In the course of the suspension polymerization, the (mostly liquid) monomer droplets polymerize to give (usually solid) monomer particles, and a suspension of polymer particles in water is obtained. The particle size of the polymer particles depends, inter alia, on the monomer droplet size and is generally 800 to 2000 μm, preferably 900 to 1100 μm, expressed as number-average particle diameter d₅₀ (in each case 50% of the particles are smaller or larger than the d₅₀ diameter).

During the suspension polymerization, a propellant can be co-used for preparing propellant-containing polymer particles, for type and amount see above. For this, the polymerization takes place at increased pressure, i.e. at above 1 bar to 50 bar, and temperatures of, for example, 50 to 150° C. Alternatively, the polymerization can also firstly be carried out without propellants and then, in a second step, the suspension of the resulting polymer particles can be subjected to the increased pressure and the elevated temperature.

Under the specified pressure and temperature conditions, the added propellant diffuses into the polymer particles. If the suspension obtained is cooled under pressure so that the propellant cannot expand within the particles, then expandable polymer particles are obtained. If the heated particle suspension is decompressed suddenly, the propellant expands into the softened particles and expanded particles are obtained. Accordingly, the polymer particles may be expandable or expanded depending on the procedure.

The invention therefore also provides a process for the preparation of expandable or expanded thermoplastic polymer particles with co-use of a propellant, wherein the polymer particles are prepared using the specified process for suspension polymerization.

The expandable or expanded polymer particles obtainable by this process are likewise provided by the invention. From these, it is possible, for example, to prepare foams (so-called particle foams) or foam moldings. The procedure is known: to prepare expanded polystyrene (Styropor®), it is possible, for example, to firstly partially expand the expandable, propellant-containing polystyrene particles according to the invention by heating in the so-called prefoaming. In the subsequent so-called full-foaming, the partially expanded polystyrene particles are poured into a mold provided with fine bores, the mold is closed and, by injecting steam or in another way, the particles are expanded, during which they weld together to give the foam or to give the finished foam molding.

The invention therefore also provides the use of the expandable or expanded polymer particles according to the invention for producing foams or foam moldings. In particular, preference is given to the use of the expandable or expanded polystyrene particles according to the invention for producing expanded polystyrene as foam or foam molding, i.e. a use in which the polymer particles are polystyrene particles and the foam or foam molding is expanded polystyrene.

### EXAMPLES

Part A: Preparation and Test of the Hydrophobins used According to the Invention

### Example 1

### Preliminary Work for the Cloning of yaad-His₆/yaaE-His₆

Using the oligonucleotides Hal570 and Hal571 (Hal 572/ Hal 573), a polymerase chain reaction was carried out. Genomic DNA from the bacterium Bacillus subtilis was used as template DNA. The PCR fragment obtained comprised the coding sequence of the gene yaaD/yaaE from Bacillus subtilis, and at the ends in each case an NcoI or BgIII restriction site. The PCR fragment was purified and cleaved with the restriction endonucleases NcoI and BgIII. This DNA fragment was used as insert, and cloned into the vector pQE60 from Qiagen linearized beforehand with the restriction endonucleases NcoI and BgIII. The vectors pQE60YAAD#2/pQE6OYaaE#5 obtained in this way can be used for the expression of proteins consisting of YAAD::HIS₆ or YME::HIS₆.

| | |
|---|---|
| HaI570: | gcgcgcccatggctcaaacaggtactga |
| HaI571: | gcagatctccagccgcgttcttgcatac |
| HaI572: | ggccatgggattaacaataggtgtactagg |
| HaI573: | gcagatcttacaagtgccttttgcttatattcc |

### Example 2

### Cloning of yaad-hydrophobin DewA-His₆

Using the oligonucleotides KaM 416 and KaM 417, a polymerase chain reaction was carried out. Genomic DNA of the mold Aspergillus nidulans was used as template DNA. The PCR fragment obtained comprised the coding sequence of the hydrophobin gene dewA and an N-terminal factor Xa proteinase cleavage site. The PCR fragment was purified and cleaved with the restriction endonuclease BamHI. This DNA fragment was used as insert, and cloned into the vector pQE60YMD#2 linearized beforehand with the restriction endonuclease BgIII.

The vector #508 produced in this way can be used for the expression of a fusion protein consisting of YAAD::Xa::dewA::HIS₆.

KaM416:
GCAGCCCATCAGGGATCCCTCAGCCTTGGTACCAGCGC
KaM417:
CCCGTAGCTAGTGGATCCATTGAAGGCCGCATGAAGTTCTCCGTCTCCGC

### Example 3

### Cloning of yaad-hydrophobin RodA-His₆

Plasmid #513 was cloned analogously to plasmid #508 using the oligonucleotides KaM 434 and KaM 435.

KaM434:
GCTAAGCGGATCCATTGAAGGCCGCATGAAGTTCTCCATTGCTGC
KaM435:
CCAATGGGGATCCGAGGATGGAGCCAAGGG

### Example 4

### Cloning of yaad-hydrophobin BASF1-His₆

Plasmid #507 was cloned analogously to plasmid #508 using the oligonucleotides KaM 417 and KaM 418.

An artificially synthesized DNA sequence—hydrophobin BASF1—was used as template DNA (see annex).

KaM417:
CCCGTAGCTAGTGGATCCATTGAAGGCCGCATGAAGTTCTCCGTCTCCGC
KaM418:
CTGCCATTCAGGGGATCCCATATGGAGGAGGGAGACAG

### Example 5

### Cloning of yaad-hydrophobin BASF2-His₆

Plasmid #506 was cloned analogously to plasmid #508 using the oligonucleotides KaM 417 and KaM 418.

An artificially synthesized DNA sequence—hydrophobin BASF2—was used as template DNA (see annex).

KaM417:
CCCGTAGCTAGTGGATCCATTGAAGGCCGCATGAAGTTCTCCGTCTCCGC
KaM418:
CTGCCATTCAGGGGATCCCATATGGAGGAGGGAGACAG

### Example 6

### Cloning of yaad-hydrophobin SC3-His₆

The plasmid #526 was cloned analogously to plasmid #508 using the oligonucleotides KaM464 and KaM465.

cDNA from Schyzophyllum commune was used as template DNA (see annex).

| | |
|---|---|
| KaM464: | CGTTAAGGATCCGAGGATGTTGATGGGGGTGC |
| KaM465: | GCTAACAGATCTATGTTCGCCCGTCTCCCCGTCGT |

### Example 7

### Fermentation of the recombinant E. coli strain yaad-hydrophobin DewA-His₆

Inoculation of 3 ml of LB liquid medium with a yaad-hydrophobin DewA-His₆ expressing E. coli strain in 15 ml Greiner tubes. Incubation for 8 h at 37° C. on a shaker at 200 rpm. Each of 2 1l Erlenmeyer flasks with baffles and 250 ml of LB medium (+100 μg/ml of ampicillin) are inoculated with 1 ml of the preculture and incubated for 9 h at 37° C. on a shaker at 180 rpm.

Inoculate 13.5 l of LB medium (+100 μg/ml of ampicillin) in a 20 l fermenter with 0.5 l of preculture (OD_{600 nm} 1:10 measured against H₂O). At an OD_{60 nm} of ˜3.5 addition of 140 ml of 100 mM IPTG. After 3 h, cool the fermenter to 10° C. and remove the fermentation broth by centrifugation. Use the cell pellet for further purification.

### Example 8

### Purification of the Recombinant Hydrophobin Fusion Protein

(Purification of Hydrophobin Fusion Proteins which have a C-terminal His6 Tag)

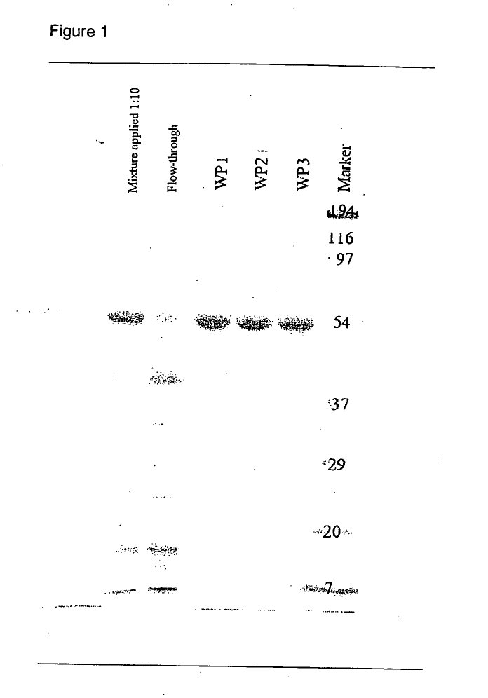

100 g of cell pellet (100-500 mg of hydrophobin) are made up to a total volume of 200 ml with 50 mM sodium phosphate buffer, pH 7.5, and resuspended. The suspension is treated with an Ultraturrax model T25 (Janke and Kunkel; IKA-Labortechnik) for 10 minutes and then incubated 1 hour at room temperature with 500 units of benzonase (Merck, Darmstadt; Order No. 1.01697.0001) to degrade the nucleic acids. Prior to cell disruption, filtration is carried out with a glass cartridge (P1). For cell disruption and for shearing the remaining genomic DNA, two homogenizer runs are carried out at 1.500 bar (microfluidizer M-110EH; Microfluidics Corp.). The homogenate is centrifuged (Sorvall RC-5B, GSA rotor, 250 ml centrifuge beaker, 60 minutes, 4° C., 12 000 rpm, 23 000 g), the supernatant is placed on ice and the pellet is resuspended in 100 ml of sodium phosphate buffer, pH 7.5. Centrifugation and resuspension are repeated three times, with the sodium phosphate buffer comprising 1% SDS for the third repetition. Following resuspension, the mixture is stirred for one hour and a final centrifugation is carried out (Sorvall RC-5B, GSA rotor, 250 ml centrifuge beaker, 60 minutes, 4° C., 12 000 rpm, 23 000 g). According to SDS-PAGE analysis, the hydrophobin is present following the final centrifugation in the supernatant (FIG. 1). The experiments show that the hydrophobin is probably present in the form of inclusion bodies in the corresponding E. coli cells. 50 ml of the supernatant comprising hydrophobin are applied to a 50 ml nickel-Sepharose High Performance 17-5268-02 column (Amersham) which has been equilibrated using 50 mM Tris-Cl pH 8.0 buffer. The column is washed with 50 mM Tris-Cl pH 8.0 buffer and the hydrophobin is then eluted using 50 mM Tris-Cl pH 8.0 buffer which comprises 200 mM imidazole. To remove the imidazole, the solution is dialyzed against 50 mM Tris-Cl pH 8.0 buffer.

FIG. 1 shows the purification of the prepared hydrophobin:

Lane 1: Mixture applied to nickel-Sepharose column (1:10 dilution)

Lane 2: Flow-through=eluate of washing step

Lanes 3-5: OD 280 peaks of the elution fractions

The hydrophobin of FIG. 1 has a molecular weight of about 53 kD. Some of the smaller bands represent degradation products of the hydrophobin.

### Example 9

### Performance Testing; Characterization of the Hydrophobin through Contact Angle Change of a Water Drop on Glass

substrate: glass (window glass, Suddeutsche Glas, Mannheim):

concentration of hydrophobin: 100 μg/mL

incubation of glass plates overnight (temperature 80° C.) in 50 mM Na acetate pH 4+0.1% polyoxyethylene (20) sorbitan monolaureate (Tween® 20)

after coating, wash in distilled water

then incubation 10 min/80° C./1% sodium dodecyl sulfate (SDS) solution in dist. water

wash in dist. water

The samples are dried in air at 20° C. and the contact angle (in degrees) of a drop of 5 μl of water is determined at room temperature.

The contact angle measurement was determined using a Dataphysics Contact Angle System OCA 15+, software SCA 20.2.0. (November 2002). The measurement was carried out in accordance with the manufacturer's instructions.

Untreated glass gave a contact angle of 30±5°; coating with the functional hydrophobin according to Example 8 (yaad-dewA-his₆) gave contact angles of 75±5°.

Part B: Emulsion Comprising Hydrophobin

### Example 10

### Preparation and Investigation of an Emulsion of Styrene in Water

Deionized water was used. For the preparation of the emulsion according to the invention, a solution of the hydrophobin (fusion protein) yaad-Xa-dewA-his (SEQ ID NO: 19) prepared as in Example 8 in water was used. The concentration of the hydrophobin in the solution was 100 mg/l (0.02% by weight).

The Pickering emulsifier used was magnesium pyrophosphate (MPP) as aqueous suspension, which was prepared as follows: at 20° C., 93.18 g of sodium pyrophosphate (Na₄P₂O₇) were dissolved in 3200 ml of water. With stirring, a solution of 172.8 g of magnesium sulfate (MgSO₄.7 H₂O) in 800 ml of water was added to this solution and the mixture was stirred for a further 5 min.

A 50 ml wide-neck bottle was used which was provided with a magnetic stirrer and comprised a Teflon®-coated stirring rod. At 20° C. and without stirring, 0.3 to 1.2 g of the hydrophobin solution were initially introduced, and 1.5 to 2.5 g of the freshly prepared MPP suspension and 15 to 20 g of water were added. This mixture was stirred for 30 sec at 700 rpm. 30 g of styrene were then added. The precise amounts of hydrophobin solution, MPP suspension and water were chosen so that the phase volume ratio styrene:water in the resulting mixture was 1.3 and the MPP content was 780 ppmw. The hydrophobin content of the mixture is given in the table below.

The resulting mixture was stirred for 17 hours at 20° C. and 700 rpm. The mixture was then left to stand for 2 hours without stirring and the resulting mixture was photographed.

The stability of the mixture and emulsion was investigated by dilution with styrene or water. For this, 0.1 ml of styrene or 0.1 ml of water was added to a 0.1 ml sample of the mixture at 20° C. and it was observed whether mixing was possible. Furthermore, by reference to the photos, the approximate size of the styrene droplets was determined.

The table summarizes the results.

TABLE
Results (C means for comparison, nd not determined)

| | Hydrophobin | Characterization of | Size of the styrene |
|---|---|---|---|
| Example | content [ppmw] | the mixture | droplets |
| 10-1C | 0 | no emulsion | — |
| 10-2 | 21 | unstable emulsion | nd |
| 10-3 | 42 | stable emulsion | a few mm |
| 10-4 | 84 | stable emulsion | μm and mm range |

Assignment of the sequence names to DNA and polypeptide sequences in the sequence protocol

| | |
|---|---|
| dewA DNA and polypeptide sequence | SEQ ID NO: 1 |
| dewA polypeptide sequence | SEQ ID NO: 2 |
| rodA DNA and polypeptide sequence | SEQ ID NO: 3 |
| rodA polypeptide sequence | SEQ ID NO: 4 |
| hypA DNA and polypeptide sequence | SEQ ID NO: 5 |
| hypA polypeptide sequence | SEQ ID NO: 6 |
| hypB DNA and polypeptide sequence | SEQ ID NO: 7 |
| hypB polypeptide sequence | SEQ ID NO: 8 |
| sc3 DNA and polypeptide sequence | SEQ ID NO: 9 |
| sc3 polypeptide sequence | SEQ ID NO: 10 |
| basf1 DNA and polypeptide sequence | SEQ ID NO: 11 |
| basf1 polypeptide sequence | SEQ ID NO: 12 |
| basf2 DNA and polypeptide sequence | SEQ ID NO: 13 |
| basf2 polypeptide sequence | SEQ ID NO: 14 |
| yaad DNA and polypeptide sequence | SEQ ID NO: 15 |
| yaad polypeptide sequence | SEQ ID NO: 16 |
| yaae DNA and polypeptide sequence | SEQ ID NO: 17 |
| yaae polypeptide sequence | SEQ ID NO: 18 |
| yaad-Xa-dewA-his DNA and polypeptide | SEQ ID NO: 19 |
| sequence | |
| yaad-Xa-dewA-his polypeptide sequence | SEQ ID NO: 20 |
| yaad-Xa-rodA-his DNA and polypeptide | SEQ ID NO: 21 |
| sequence | |
| yaad-Xa-rodA-his polypeptide sequence | SEQ ID NO: 22 |
| yaad-Xa-basf1-his DNA and polypeptide | SEQ ID NO: 23 |
| sequence | |
| yaad-Xa-basf1-his polypeptide sequence | SEQ ID NO: 24 |

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. An emulsion of hydrophobic monomers in water comprising inorganic particles as Pickering emulsifiers, and hydrophobin.

21. The emulsion of claim 20 wherein the monomer is styrene, wherein co-monomers can be co-used and are selected from the group consisting of α-methylstyrene, ring-halogenated styrenes, ring-alkylated styrenes, acrylonitrile, esters of acrylic acid or methacrylic acid of C₁₋₈-alcohols, N-vinyl compounds, butadiene, divinylbenzene and butanediol diacrylate.

22. The emulsion of claim 20 wherein the inorganic particles are chosen from particles comprising magnesium pyrophosphate, barium sulfate, zinc oxide and calcium phosphate.

23. The emulsion of claim 20 wherein the hydrophobin has the general formula (I)
Xₙ-C¹-X₁₋₅₀-C²-X₀₋₅-C³-X₁₋₁₀₀-C⁴-X₁₋₁₀₀-C⁵-X₁₋₅₀-C⁶-X₀₋₅-C⁷-X₁₋₅₀-C⁸-Xₘ (I)
wherein X independently is any of the 20 naturally occurring amino acids, the numerical subscripts of X indicate the number of amino acids of each X, C is cysteine, alanine, serine, glycine, methionine or threonine wherein at least four residues designated as C are cysteine, and the subscripts n and m of X independently are natural numbers of X from 0 to 500.

24. The emulsion of claim 20 wherein the hydrophobin has the general formula (II)
Xₙ-C¹-X₃₋₂₅-C²-X₀₋₂-C³-X₅₋₅₀-C⁴-X₂₋₃₅-C⁵-X₂₋₁₅-C⁶-X₀₋₂-C⁷-X₃₋₃₅-C⁸-Xₘ (II)
wherein X independently is any of the 20 naturally occurring amino acids, the numerical subscripts of X indicate the number of amino acids of each X, C is cysteine, alanine, serine, glycine, methionine or threonine wherein at least four residues designated as C are cysteine, and the subscripts n and m of X independently are natural numbers of X from 0 to 300.

25. The emulsion of claim 20 wherein the hydrophobin is chosen from the types dewA, rodA, hypA, hypB, sc3, basf1 and basf2.

26. The emulsion of claim 20 wherein the monomer is styrene, the inorganic particles comprise magnesium pyrophosphate, and the hydrophobin is that described in SEQ ID NO: 19.

27. The emulsion of claim 20 comprising no organic emulsifiers or surfactants.

28. A process for the preparation of the emulsion of claim 20 wherein the monomers are dispersed in water in the presence of inorganic particles that act as Pickering emulsifiers and wherein hydrophobin is co-used.

29. A process for the suspension polymerization of hydrophobic monomers in water with co-use of inorganic particles as Pickering emulsifiers and wherein hydrophobin is co-used.

30. The process of claim 29 wherein the emulsion of claim 20 is used as feed material.
